(19) United States
(12) Patent Application Publication
(10) Pub. No.: US 2012/0188236 A1
(43) Pub. Date: Jul. 26, 2012

(54) System, Method and Apparatus for Visualizing Changes in Cylindrical Volumes

(76) Inventors: Fabienne Legendre, Chatou (FR); Koji Ito, Sugar Land, TX (US); Christian Stolte, Winsen (DE); John C. Rasmus, Richmond, TX (US); Shahzad A. Asif, Richmond, TX (US)

(21) Appl. No.: 13/375,521

(22) PCT Filed: Sep. 21, 2009
(86) PCT No.: PCT/US09/57634

§ 371 Date: Apr. 12, 2012

Related U.S. Application Data
(60) Provisional application No. 61/184,220, filed on Jun. 4, 2009.

(51) Int. Cl. G06T 15/00

(52) U.S. Cl. 345/419

(57) ABSTRACT

A method includes interpreting first dimensional data such as a caliper log for a wellbore at a first time, and interpreting second dimensional data such as a caliper log for the wellbore at a second time. The method further includes determining a dimensional differential in response to the first dimensional data and the second dimensional data. The dimensional differential includes a volume difference between cross-sectional profiles from the first dimensional data and the second dimensional data. The cross-sectional profiles for comparison may be at a specified axial location or range of axial locations in the wellbore. The method includes graphically displaying the dimensional differential by marking the dimensional differential with a first marker index where the first dimensional data is inside the second dimensional data, and with a second marker index where the first dimensional data is outside the second dimensional data.

### BACKGROUND

The technical field generally relates to determining and visualizing changes in cylindrical volumes over time. The technical field more particularly but not exclusively relates to visualizing changes in a wellbore cross-section over time.

Various tools exist in the present art to determine a cross-sectional shape of a cylindrical volume such as a wellbore, including caliper logs and determinations from ultrasonic information. The value of such information can be in the absolute data (e.g. to determine displacement volumes, etc.) but the value can also be in the amount of change of the data over time. However, presently available methods of collecting and displaying data for cylindrical volumes do not provide a way to visualize the axial position, the magnitude, and the direction of data changes over time.

Cylindrical volumes occur in many applications, and changes in the cross-sectional area of the cylindrical volume have various uses within those applications. Reduction in cross-sectional area can be indicative of deposits, build-up, corrosion, invasion, or other changes that are not apparent from the visually accessible areas of the cylindrical volume. Increases in cross-sectional are can be indicative of wash-outs, erosion, aneurysm, wall failure, corrosion, or other changes that are likewise not apparent from the visually accessible areas of the cylindrical volume. Such changes are also difficult to determine from merely updated determinations of the cylindrical volume geometry. Therefore, further technological developments are desirable in this area.

### SUMMARY

One embodiment is a unique method for determining a dimensional differential between two or more points in time, and graphically displaying the dimensional differential. Other embodiments include unique systems and apparatus to provide two-dimensional or three-dimensional displays of the dimensional differential. Further embodiments, forms, objects, features, advantages, aspects, and benefits shall become apparent from the following description and drawings.

### BRIEF DESCRIPTION OF THE DRAWINGS

FIG. 1 is a schematic diagram of a system for visualizing changes in a cylindrical volume.

FIG. 2 is a schematic diagram of a processing subsystem that executes certain operations to display changes in a cylindrical volume.

FIG. 3 is an illustration of a first and second cross-sectional profile, marked with a first and second marking index.

FIG. 4 is an illustration of a three-dimensional view of a plurality of cross-sectional profiles, marked with a first and second marking index.

FIG. 5 is an illustration of a first, second, and third cross-sectional profile, marked with a third through eighth marking index.

FIG. 6 is an illustration of a three-dimensional view of a plurality of cross-sectional profiles, marked with a third through eighth marking index.

FIG. 7 is an illustration of a marking index catalog.

FIG. 8 is a schematic flow diagram of a technique for visualizing changes in a cylindrical volume.

FIG. 9 is a schematic flow diagram of an alternate technique for visualizing changes in a cylindrical volume.

FIG. 10 is a schematic flow diagram of another technique for visualizing changes in a cylindrical volume.

FIG. 11 is a schematic flow diagram of a technique for graphically displaying a dimensional differential.

FIG. 12 is a schematic flow diagram of a procedure for visualizing changes in a volume associated with a wellbore.

### DESCRIPTION OF THE ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, any alterations and further modifications in the illustrated embodiments, and any further applications of the principles of the invention as illustrated therein as would normally occur to one skilled in the art to which the invention relates are contemplated herein.

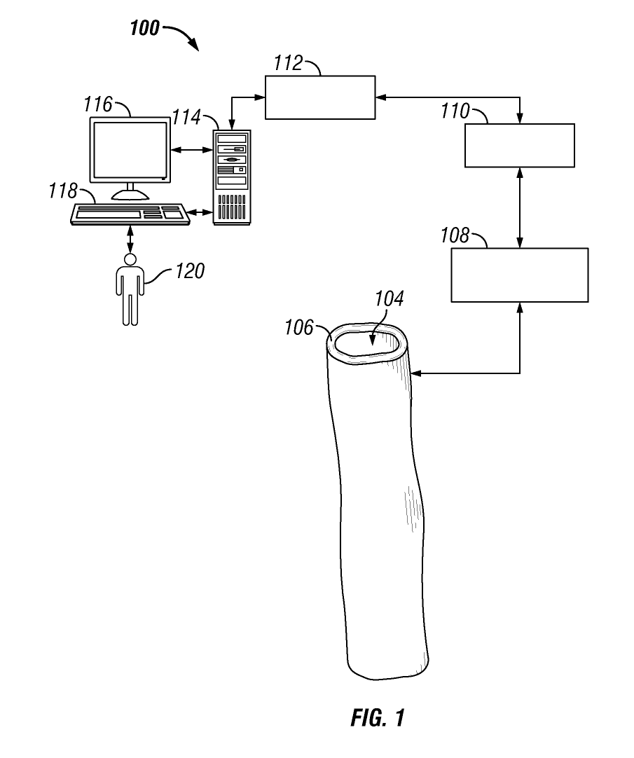

FIG. 1 is a schematic diagram of a system 100 for visualizing changes in a cylindrical volume 104. The system 100 includes a physical boundary 106 defining a cylindrical volume 104. A cylindrical volume 104, as used herein, refers to a shape having a relatively high aspect ratio, where the axial length is considerably longer than the average diameter. They cylindrical volume 104 has a relatively similar cross-section throughout the axial length, although considerable variation of the cross-section shape and size is contemplated herein. The cross-section may be generally circular or elliptical, but may also be any other shape and need not be regular.

For example, a cylindrical volume 104 may include the interior volume of an artery, and the artery may have ballooning (e.g. an aneurysm), restriction, or even total blockage, causing significant variability of the cross-sectional shape and size within the artery. Further, the artery may have cross-sectional changes due to artificial devices such as a stent or a stent with a structural failure that provides a varied cross-sectional volume within the artery.

In another example, a cylindrical volume 104 includes the interior volume of a wellbore, where the wellbore has washout areas with a greater diameter and areas with collapse, debris, or migration due to geologic stresses with a lesser diameter. The wellbore may be vertical, deviated, directional, and/or horizontal. Specific, non-limiting examples of the physical boundary 106 defining the cylindrical volume 104 include a wellbore, a pipe, a fluid conduit, a blood vessel, and/or a biological conduit.

The system 100 further includes data gathering equipment 108 which includes any equipment understood in the art to determine dimensional data corresponding to the physical boundary 106. The data gathering equipment 108 may be well logging equipment including a caliper tool, an ultrasonic tool, and/or a resistivity tool. The nature of the data gathering equipment 108 depends upon the physical boundary 106 and the type of dimensional data to be taken, and the selection of appropriate data gathering equipment 108 is a mechanical step for one of skill in the art with the benefit of the disclosures herein.

The system 100 further includes dimensional data 110 corresponding to the physical boundary 106, where the dimensional data 110 includes data taken during at least two separate points in time. Non-limiting examples of dimensional data 110 include a physical extent of the physical boundary 106, azimuthal borehole size and/or shape of the physical boundary 106, an invasion extent of a fluid into a matrix surrounding the physical boundary 106, and/or a cement bond quality. The dimensional data 110 will typically include an azimuthal aspect, where the magnitude of the data measurement can be directionally correlated in the cylindrical volume 104. However, certain embodiments include dimensional data 110 that does not include an azimuthal aspect. While each set of dimensional data 110 has an independent time value (or range of time values associated with the dimensional data 110), each set of dimensional data 110 may further include other independent identifying parameters. In one example, the dimensional data 110 may be cement bonding data correlated to a pressure in a wellbore. In another example, the dimensional data 110 may be associated with an amount of fluid injected into or produced from the wellbore since a reference point, an amount of usage associated with the physical boundary 106, an accumulated amount of drugs taken by a host including the artery since a reference point, a treatment index, or any other reference parameter that distinguishes each set of dimensional data 110 and is understood by one of skill in the art based upon the nature of the system 100. The treatment index includes a value indicating a quantity of a treatment applied that would potentially affect the cylindrical volume as part of the treatment or a side effect. For example, a treatment may remove corrosion, reduce blockage, cause wash out in a wellbore, induce wear in the physical boundary 106, or have some other potential effect on the cylindrical volume 104 wherein it may be of interest to determine the dimensional data 110 at two or more times during the treatment to monitor effectiveness or side effects.

The system 100 further includes a controller 112 structured to execute certain operations for visualizing changes in cylindrical volumes 104. The controller 112 is shown as a single device to simplify description. However, the controller 112 may include multiple devices, distributed devices, some devices that are hardware and/or include a software component, and devices that are part of other devices shown on the system 100, including the data gathering equipment 108 and/or a user computer 114. Further, the dimensional data 110 may be stored on the controller 112 and/or communicated to the controller 112. The controller 112 may include devices that are physically remote from other components of the system 100 but that are at least intermittently in communication with the system via network, datalink, internet, or other communication means.

The controller 112 includes modules structured to functionally execute operations for visualizing changes in cylindrical volumes 104. The description herein includes the use of modules to highlight the functional independence of the features of the elements described. A module may be implemented as operations by software, hardware, or at least partially performed by a user or operator. In certain embodiments, modules represent software elements as a computer program encoded on a computer readable medium, wherein a computer performs the described operations when executing the computer program. A module may be a single device, distributed across devices, and/or a module may be grouped in whole or part with other modules or devices. The operations of any module may be performed wholly or partially in hardware, software, or by other modules. The presented organization of the modules is exemplary only, and other organizations that perform equivalent functions are contemplated herein. Modules may be implemented in hardware and/or software on computer readable medium, and modules may be distributed across various hardware or software components.

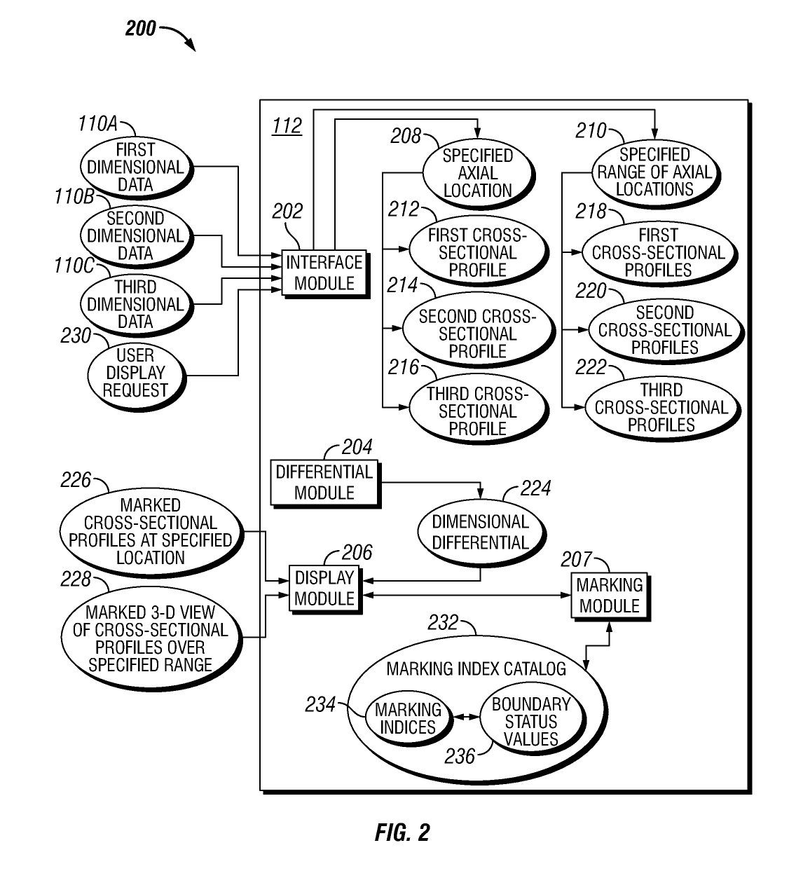

The controller 112 includes an interface module, a differential module, a marking module, and/or a display module. The interface module interprets the dimensional data 110 and/or user requests from a user 120 communicating with the controller 112 via a user input 118. The differential module determines a dimensional differential in response to the dimensional data 110, and the display module provides a display of the dimensional differential to the user 120, for example on a user display 116. The display module may provide the display of the dimensional differential via a printout, electronically, stored on a computer readable medium, or through any other means understood in the art. The marking module determines a marking scheme, for example marking indices selected from a marking index catalog, for the dimensional differential, and the display module utilizes the marking scheme to display the dimensional differential. More detailed descriptions of specific embodiments of the controller 112 are included in the description referencing FIG. 2.

FIG. 2 is a schematic diagram 200 including a controller 112 that executes certain operations to display changes in a cylindrical volume 104.

An exemplary embodiment of the controller 112 includes an interface module 202 that interprets a first dimensional data 110a corresponding to a wellbore at a first time, and that interprets a second dimensional data 110b corresponding to the wellbore at a second time. The interface module 202, in certain embodiments, further interprets a third dimensional data 110c corresponding to the wellbore at a third time. The term interpreting, as used herein, includes obtaining the dimensional data 110 by any method understood in the art, including at least reading the data from a memory location, receiving the data in a communication such as a message over a network or datalink, receiving the data or a data precursor via one or more sensors, and calculating the data from preliminary parameters available to the interface module 202 by any method.

The controller 112 further includes a differential module 204 that determines a dimensional differential 224 in response to the first dimensional data 110a and the second dimensional data 110b. The dimensional differential 224 includes a differential volume between the first dimensional data 110a and the second dimensional data 110b. The controller 112 further includes a display module 206 that graphically displays the dimensional differential 224.

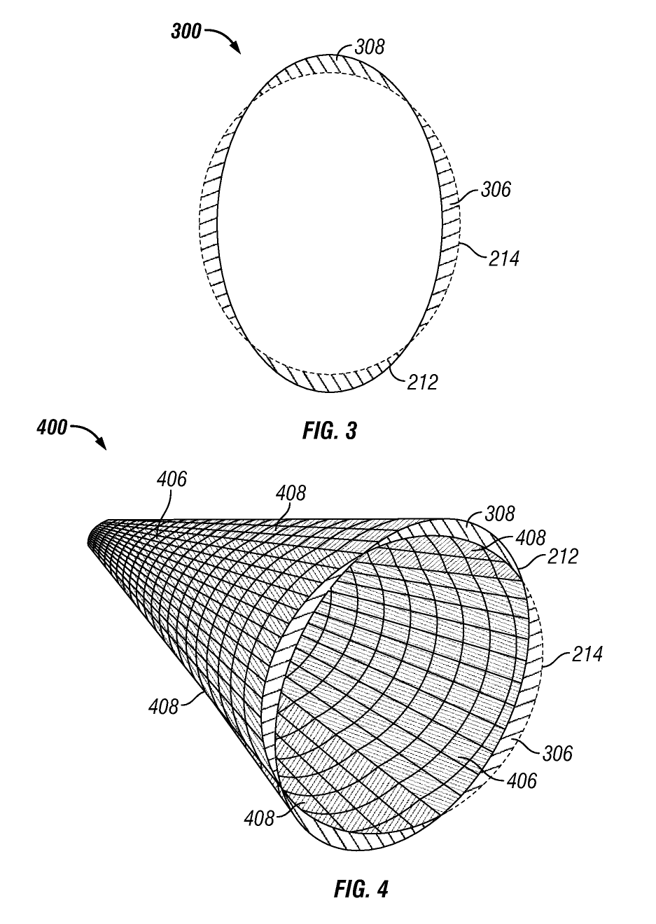

In certain embodiments, the differential module 204 further determines a first cross-sectional profile 212 at a specified axial location 208 of the wellbore from the first dimensional data 110a, and determines a second cross-sectional profile 214 at the specified axial location 208 of the wellbore from the second dimensional data 110b. Referencing FIG. 3, the first cross-sectional profile 212 and a second cross-sectional profile 214 are shown, and the dimensional differential 224 comprises the difference between the first cross-sectional profile 212 and a second cross-sectional profile 214. The display module 206 further marks the dimensional differential 224 with a first marking index 306 where the first cross-sectional profile 212 is inside the second cross-sectional profile 214, and marks the dimensional differential 224 with a second marking index 308 where the first cross-sectional profile 212 is outside the second cross-sectional profile 214. The display module 206 provides the marked cross-sectional profiles 226 at the specified axial location 208.

The marking indexes 306, 308 are shown as distinct cross-hatches in the illustration of FIG. 3, however any distinction known in the art, including at least shading, colors, cross-hatching, and/or marked gradients, may be utilized as a marking index 306, 308. The use of a gradient can provide an easily visualized representation of how much change has occurred between measurements in a given region. In certain embodiments, the marking indices 306, 308 use a first color (or marking index type) where change is in a positive direction (e.g. a growing wellbore diameter), a second color (or marking index type) where change is in a negative direction, and a neutral color (e.g. white, gray, a background color) or one of the first and second color (or marking index type) at a reduced intensity where little change has occurred. In an exemplary embodiment, the dimensional differential 224 with is marked with a neutral marking index and/or a reduced intensity marking index when the dimensional differential 224 is below a threshold amount. Thus, the display 300 of the dimensional differential 224 provides an easy reference for the user 120 to visualize changes in the volume defined in the dimensional data 110. In certain embodiments, the interface module 202 further interprets the specified axial location 208 as a dynamic input, for example as a part of a user display request 230.

In certain embodiments, the differential module 204 further determines a first number of cross-sectional profiles 218 corresponding to a specified range of axial locations 210 of the wellbore from the first dimensional data 110a, and determines a second number of cross-sectional profiles 220 corresponding to the specified range of axial locations 210 of the wellbore from the second dimensional data 110b. Referencing FIG. 4, a three-dimensional (3-D) view 400 is shown of the cross-sectional profiles 218, 220 over the specified range of axial locations 210. The display module 206 further marks the dimensional differential 224 with a first marking index 306, 406 where the first cross-sectional profiles 218 are inside the second cross-sectional profiles 220, and marks the dimensional differential 224 with a second marking index 308, 408 where the first cross-sectional profiles 218 are outside the second cross-sectional profiles 220.

In the illustration, the first marking index on the displayed face of the 3-D view 400 is a first marking representation 306 and the first marking index on the axially projected portion of the 3-D view 400 is a separate marking representation 406, which may be selected according to what type of display provides the easiest representation to visualize. The first marking index 306, 406 includes, in certain embodiments, utilizing different types of marking for different types of display elements (e.g. data shown in different dimensions, gradients within the data displayed, different marking schemes for different types of data, a marking scheme selected to make the face of the 3-D view 400 easily visualized, etc.). The second marking index likewise shows a marking representation 308 on the displayed face and another marking representation 408 on the axially projected portion of the 3-D view 400. Thus, the 3-D view 400 provides an easy reference for the user 120 to visualize changes in the volume defined in the dimensional data 110 over the specified range of axial locations 210.

In certain embodiments, the interface module 202 further interprets a user display request 230 and the display module 206 dynamically updates the graphical display of the dimensional differential 224 in response to the user display request 230. The user display request 230 can be any display parameter understood in the art, including at least the specified axial location 208, the specified range of axial locations 210, a dimensional data type (e.g. switching between wellbore geometry and fluid invasion), a viewing angle, a viewing orientation, a viewing zoom level, and/or a marking index catalog selection. For example, user display request 230 could be used to switch the marking indices 306, 308, 406, 408 could be switched between colors and shading.

Another exemplary embodiment of the controller 112 includes an interface module 202 that interprets first dimensional data 110a corresponding to a physical boundary 106 defining a cylindrical volume 104 at a first time, and that interprets second dimensional data 110b corresponding to the physical boundary 106 defining the cylindrical volume 104 at a second time. The controller 112 further includes a differential module 204 that determines a dimensional differential 224 in response to the first dimensional data 110a and the second dimensional data 110b, and a display module 206 that graphically displays the dimensional differential 224, for example as marked cross-sectional profiles 226 at a specified location or as a marked 3-D view of cross-sectional profiles over a specified range 228.

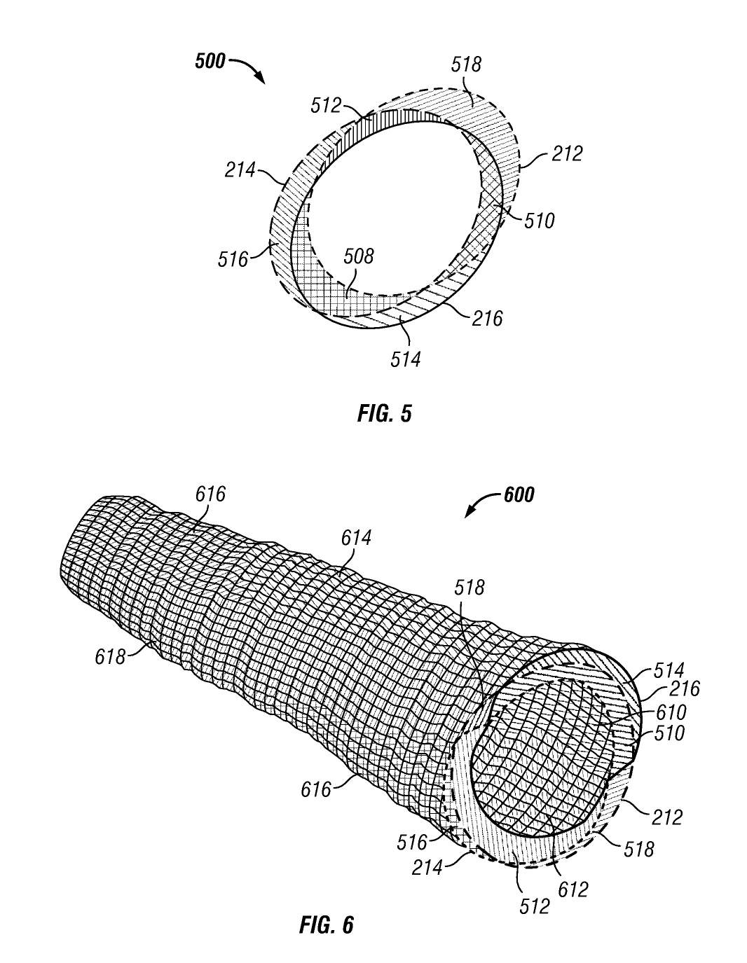

In certain embodiments, the interface module 202 further interprets third dimensional data 110c corresponding to the physical boundary 106 defining the cylindrical volume 104 at a third time, and the differential module 204 determines the dimensional differential 224 of the physical boundary 106 further in response to the third dimensional data 110c. The display module 206 further shows an inside portion of the physical boundary 106 including the intersection of the most interior data from the first, second, and third dimensional data 110a, 110b, 110c. The display module 206 further marks the inside portion with a third marking index, a fourth marking index, or a fifth marking index, where the first dimensional data 110a, the second dimensional data 110b, or the third dimensional data 110c, respectively, are the most interior data. Referencing FIG. 5, a first cross-sectional profile 212, a second cross-sectional profile 214, and a third cross-sectional profile 216 are illustrated, with the inside portions 508, 510, 512 determined from the intersection of the most interior data of the cross-sectional profiles 212, 216, 216. The inside portions 508, 510, 512 are marked with a third marking index where the first cross-sectional profile 212 is the interior profile (e.g. at portion 508), with a fourth marking index where the second cross-sectional profile 214 is the interior profile (e.g. at portion 510), and with a fifth marking index where the third cross-sectional profile 216 is the interior profile (e.g. at portion 512). The inside portions 508, 510, 512 are illustrated as marked with distinct cross-hatch patterns, but may be marked with any marking type understood in the art, including without limitation shading, colors, cross-hatching, and/or marked gradients.

The display module 206 further shows an outside portion of the physical boundary including the intersection of the most exterior data from the first, second, and third dimensional data 110a, 110b, 110c. The display module 206 further marks the outside portion with a sixth marking index, a seventh marking index, or an eighth marking index, where the third dimensional data 110c, the second dimensional data 110b, or the first dimensional data 110a, respectively, are the most exterior data. Again referencing FIG. 5, the outside portions 514, 516, 518 are marked with a sixth marking index where the third cross-sectional profile 216 is the exterior profile (e.g. at portion 514), with a seventh marking index where the second cross-sectional profile 214 is the exterior profile (e.g. at portion 516), and with an eighth marking index where the first cross-sectional profile 212 is the exterior profile (e.g. at portion 518).

The controller 112 further includes, in certain embodiments, a marking module 207 that interprets a marking index catalog 232 including a number of marking indices 234 corresponding to a number of boundary status values 236, each boundary status value 236 including one of the cross-sectional profiles 212, 214, 216, 218, 220, 222 paired with one of the inner-most and outer-most positions (e.g., referencing FIG. 5, inner-most positions 508, 510, 512 or outer-most positions 514, 516, 518). The display module 206 further marks each interior area 508, 510, 512 with the marking index 234 corresponding to the boundary status value 236 matching the inner-most cross-sectional profile, where each interior area 508, 510, 512 is the dimensional differential 224 between an inner-most cross-sectional profile and a middle cross-sectional profile. The display module 206 further marks each exterior area 514, 516, 518 with the marking index 234 corresponding to the boundary status value 236 matching the outer-most cross-sectional profile, where each exterior area 514, 516, 518 is the dimensional differential 224 between an outer-most cross-sectional profile and the middle cross-sectional profile.

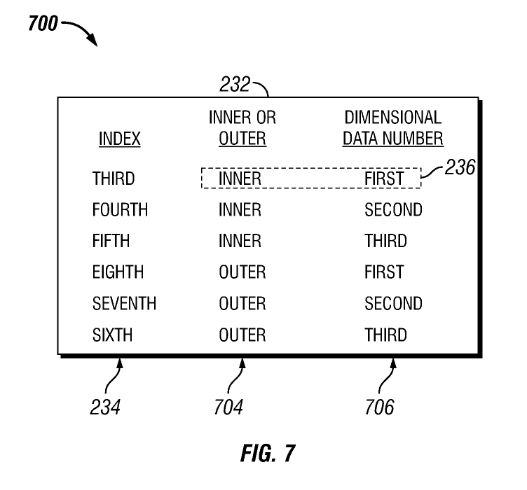

Referencing FIG. 7, a marking index catalog 232 is illustrated having a number of marking indices 234 corresponding to a number of boundary status values 236, where each boundary status value 236 is a position indicator 704 (one of the inner-most or outer-most positions) paired with a dimensional data number 706 indicating which of the cross-sectional profiles is associated with the boundary status value 236. For example, the specifically illustrated boundary status value 236 is INNER and FIRST, indicating that the marking index THIRD is to be utilized where the FIRST cross-sectional profile 212 is the INNER-most cross-sectional profile. The marking index catalog 232 is a convenient scheme to organize marking indices 234 associated with boundary status values 236, but any organizational scheme understood in the art is contemplated herein. Each marking index 234 may be a color, a cross-hatching, and/or a shading.

In certain embodiments, the marking indices 234 each have a distinct appearance. In certain embodiments, some of the marking indices 234 may have an identical appearance. For example, in the illustration of FIG. 7, the THIRD and SIXTH marking indices 234 may be an identical appearance (e.g. RED) as the THIRD marking index is utilized to mark an INNER portion and the SIXTH marking index is utilized to mark an OUTER portion. In the specific example, providing the THIRD and SIXTH marking indices 324 with identical appearances highlights, for example, a monotonically expanding wellbore over time. In another example, the FIFTH and EIGHTH marking indices 234 may have an identical appearance (e.g. BLUE) as the FIFTH marking index is utilized to mark an INNER portion and the EIGHTH marking index is utilized to mark an OUTER portion. In the specific example, providing the FIFTH and EIGHTH marking indices 324 with identical appearances highlights, for example, a monotonically shrinking wellbore over time.

Some embodiments may highlight a maximum or minimum during the second dimensional data 110b, for example to determine whether competing processes (e.g. wear increasing a diameter while corrosion decreases the diameter) culminate at an observable time. The utility of utilizing marking indices 234 that have distinct appearances or that have some shared appearances depends upon the specifics of the system 100, including the available computing resources, display methods, and the features of the cylindrical volume 104 that are desirable to emphasize, and can be determined by one of skill in the art having the benefit of the disclosures herein. The marking indices 234 include shading, cross-hatching, colors, a marked gradient, or any other type of appearance indicator according to the display media, the preferences of the system user, and other choices known in the art. In certain embodiments, at least one of the marking indices 234 is a non-mark, a blank indicator, a neutral color, or similar feature. The use of a neutral or blank marking index 234 can include portions where little change has occurred between the measurements, or where change that has occurred meets expectations and may not be change that is of interest.

In certain embodiments, the differential module 204 determines the dimensional differential 224 in response to a number of first cross-sectional profiles 218, a number of second cross-sectional profiles 220, and a number of third cross-sectional profiles 222, through a specified range of axial locations 210. The display module 206 further graphically displays the dimensional differential 224 by showing an inside portion of the physical boundary 106 that is the intersection of the most interior data from the first, second, and third dimensional data 110a, 110b, 110c. The display module 206 further marks the inside portion with a third marking index where the first dimensional data 110a is the most interior, marks the inside portion with a fourth marking index where the second dimensional data 110b is the most interior, and marks the inside portion with a fifth marking index where the third dimensional data 110c is the most interior.

Referencing FIG. 6, at the axial location corresponding to the displayed face including the first cross-sectional profile 212, the second cross-sectional profile 214, and the third cross-sectional profile 216, the region 510 includes an inside portion wherein the second dimensional data 110b (defining the second cross-sectional profile 214) is the most interior, and the region 512 includes an inside portion wherein the third dimensional data 110c (defining the third cross-sectional profile 216) is the most interior. The region 514 includes an exterior portion wherein the third dimensional data 110c is the most exterior, the region 516 includes a portion wherein the second dimensional data 110b is the most exterior, and two regions 518 include exterior portions where the first dimensional data 110a (defining the first cross-sectional profile 212) is the most exterior.

The display module 206 further graphically displays the dimensional differential 224 by showing an outside portion of the physical boundary 106 that is the intersection of the most exterior data from the first, second, and third dimensional data 110a, 110b, 110c, and marks the outside portion with a sixth marking index where the third dimensional data 110c is the most exterior, marks the outside portion with a seventh marking index where the second dimensional data 110b is the most exterior, and marks the outside portion with an eighth marking index where the first dimensional data 110a is the most exterior. Referencing FIG. 6, the regions 618 include outside portions wherein the first dimensional data 110a is the most exterior, the regions 616 include an outside portion wherein the second dimensional data 110b is the most exterior, and the region 614 includes an outside portion wherein the third dimensional data 110c is the most exterior. The region 610 includes an inside portion wherein the second dimensional data 110b is the most interior, and the region 612 includes an inside portion wherein the third dimensional data 110c is the most interior.

In the examples, inside portions and outside portions of the physical boundary 106 are described as the intersection of the inner-most and outer-most portions of the dimensional data 110a, 110b, 110c, which can describe any volumetric feature described by the data including at least a fluid invasion extent, a directional wellbore dimension, or other parameter understood in the art. As described with reference to FIG. 4, a marking index may include a first marking representation for a region illustrated at the displayed face of the 3-D view 600 and a separate marking representation for the axially projected portion of the 3-D view 600, for example the region 518 and the region 618 may utilize different marking representations even though both regions 518, 618 correspond to areas where the first dimensional data 110a are the outermost data.

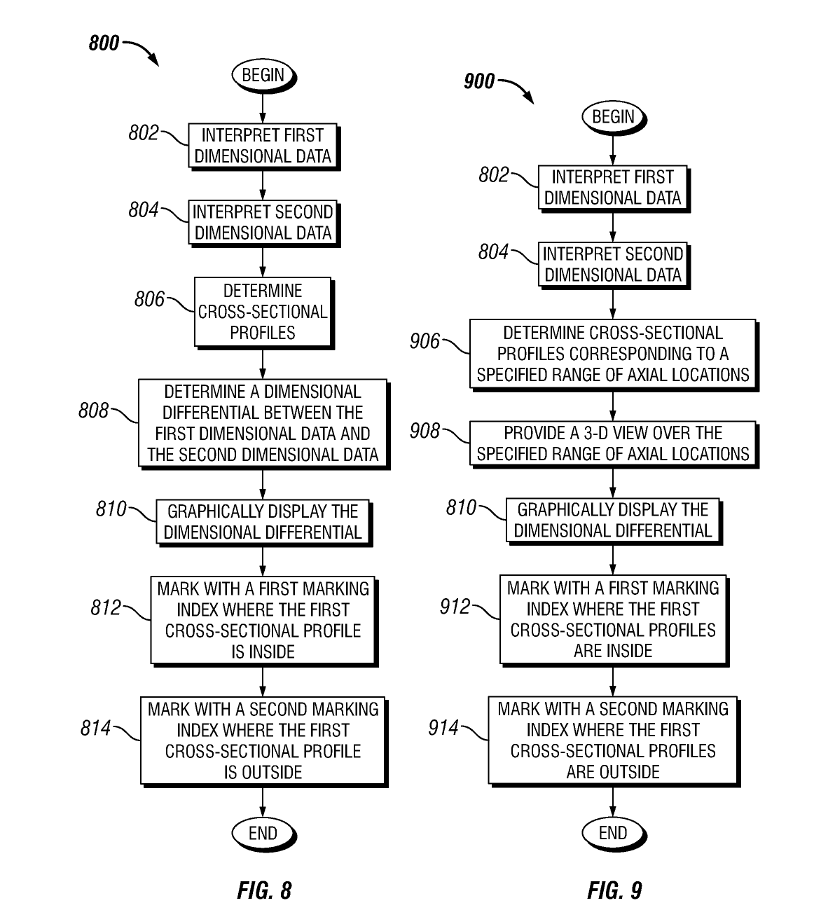

The schematic flow diagrams in FIGS. 8 to 12, and related descriptions which follow, provide illustrative embodiments of performing techniques or procedures for visualizing changes in cylindrical volumes. Operations illustrated are understood to be exemplary only, and operations may be combined or divided, and added or removed, as well as re-ordered in whole or part, unless stated explicitly to the contrary herein. Operations illustrated may be implemented by a computer executing a computer program product on a computer readable medium, where the computer program product comprises instructions causing the computer to execute one or more of the operations.

FIG. 8 is a schematic flow diagram of a technique 800 for visualizing changes in a cylindrical volume. The technique 800 may be performed where a physical boundary defining the cylindrical volume is a wellbore, a pipe, a fluid conduit, a blood vessel, and/or a biological conduit. The dimensional data (first, second, third, or more) includes a physical extent of the physical boundary, an invasion extent of a fluid into a matrix surrounding the physical boundary, and/or a cement bond quality.

The technique 800 includes an operation 802 to interpret a first dimensional data corresponding to a physical boundary defining a cylindrical volume at a first time, and an operation 804 to interpret a second dimensional data corresponding to the physical boundary defining the cylindrical volume at a second time. In certain embodiments, the technique 800 includes an operation 806 to determine a first cross-sectional profile at a specified axial location of the physical boundary from the first dimensional data, and to determine a second cross-sectional profile at the specified axial location of the physical boundary from the second dimensional data. The technique 800 further includes an operation 808 to determine a dimensional differential between the first dimensional data and the second dimensional data, and an operation 810 to graphically display the dimensional differential.

The technique 800 further includes an operation 812 to mark the dimensional differential with a first marking index where the first cross-sectional profile is inside the second cross-sectional profile, and an operation 814 to mark the dimensional differential with a second marking index where the first cross-sectional profile is outside the second cross-sectional profile.

FIG. 9 is a schematic flow diagram of an alternate technique 900 for visualizing changes in a cylindrical volume. The technique 900, in addition or replacement to certain operations in the technique 800, includes an operation 906 to determine a number of cross-sectional profiles corresponding to a specified range of axial locations of the physical boundary from the first dimensional data, and an operation 908 to provide a three-dimensional view of the physical boundary over the specified range of axial locations. The technique 900 further includes an operation 912 to mark the dimensional differential with a first marking index at positions where the cross-sectional profiles from the first dimensional data are inside the cross-sectional profiles from the second dimensional data, and an operation 914 to mark the dimensional differential with a second marking index where the cross-sectional profiles from the first dimensional data are outside the cross-sectional profiles from the second dimensional data.

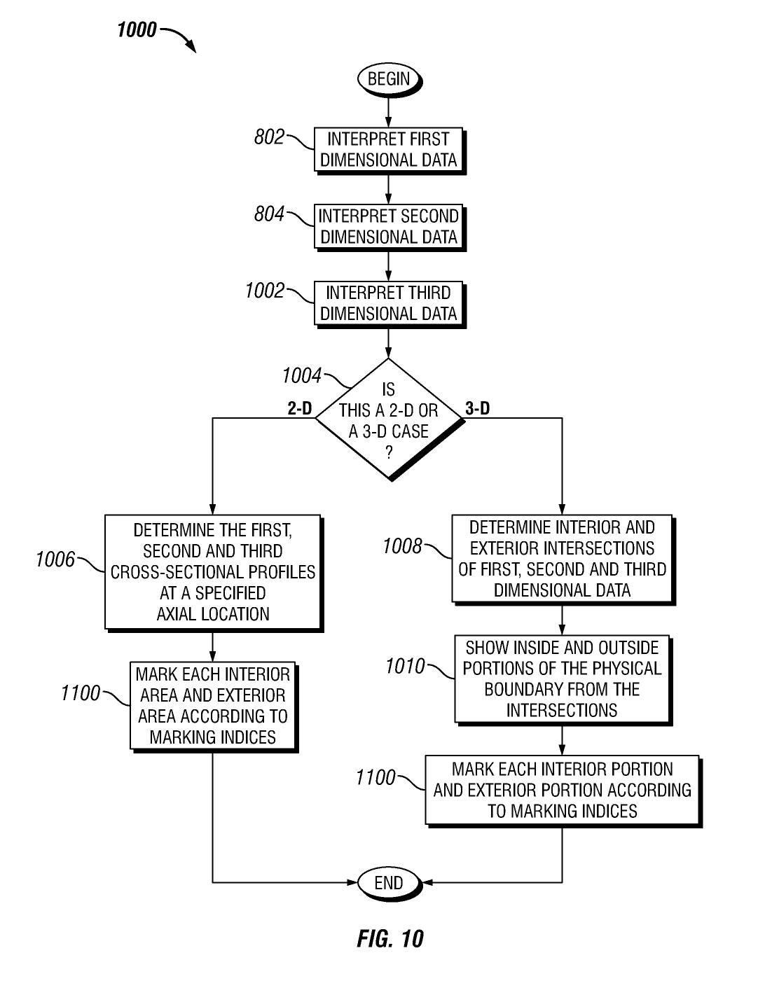

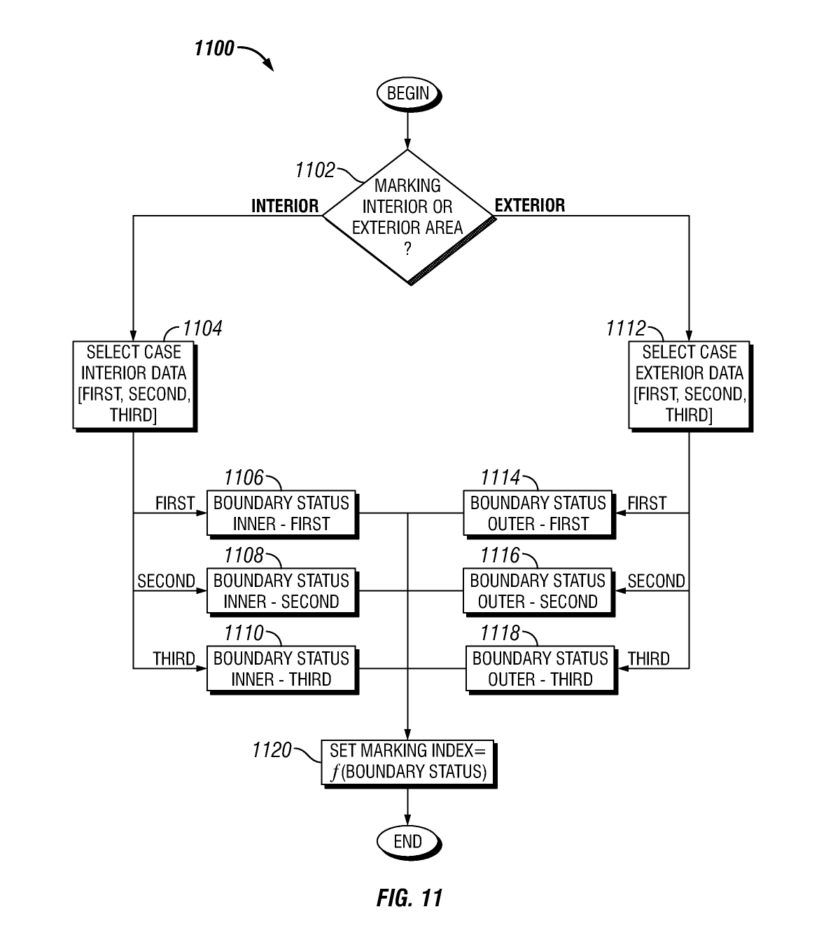

FIG. 10 is a schematic flow diagram of another technique 1000 for visualizing changes in a cylindrical volume. The technique 1000, in addition or replacement to certain operations in the technique 800, includes an operation 1002 to interpret a third dimensional data corresponding to the physical boundary defining the cylindrical volume at a third time. The technique 1000 further includes an operation 1004 to determine whether the technique 1000 is in a 2-D or 3-D environment.

Where the technique 1000 is in a 2-D environment, the technique 1000 includes an operation 1006 to determine first, second, and third cross-sectional profiles at a specified axial location of the physical boundary, and an operation 1100 to mark each interior area and exterior area according to marking indices. A detailed example of marking each interior area and exterior area according to marking indices is provided in the discussion referencing FIG. 11.

Where the technique 1000 is in a 3-D environment, the technique 1000 includes an operation 1008 to determine interior and exterior intersections of the first, second, and third dimensional data over a specified range of axial locations. The technique 1000 further includes an operation 1010 to show an inside portion of the physical boundary from the interior intersections and to show an outside portion of the physical boundary from the exterior intersections. The technique further includes an operation 1100 to mark each interior portion and exterior portion according to marking indices. A detailed example of marking each interior portion and exterior portion according to marking indices is provided in the discussion referencing FIG. 11.

FIG. 11 is a schematic flow diagram of a technique 1100 for graphically displaying a dimensional differential. The technique 1100 includes an operation 1102 to determine whether an area (or portion) to be marked is an interior or exterior area. Where the operation 1102 indicates an interior area, the technique 1100 includes an operation 1104 to determine whether the inner-most data is from the first, second, or third dimensional data. Where the inner-most data is from the first dimensional data, the technique 1100 includes an operation 1106 to determine the boundary status value as INNER-FIRST. Where the inner-most data is from the second dimensional data, the technique 1100 includes an operation 1108 to determine the boundary status value as INNER-SECOND. Where the inner-most data is from the third dimensional data, the technique 1100 includes an operation 1110 to determine the boundary status value as INNER-THIRD.

Where the operation 1102 indicates an exterior area, the technique 1100 includes an operation 1112 to determine whether the outer-most data is from the first, second, or third dimensional data. Where the outer-most data is from the first dimensional data, the technique 1100 includes an operation 1114 to determine the boundary status value as OUTER-FIRST. Where the outer-most data is from the second dimensional data, the technique 1100 includes an operation 1116 to determine the boundary status value as OUTER-SECOND. Where the outer-most data is from the third dimensional data, the technique 1100 includes an operation 1118 to determine the boundary status value as OUTER-THIRD.

The operation 1100 includes an operation 1120 to set a marking index as a function of the boundary status value. For example, referencing FIG. 7, where the boundary status value is OUTER-FIRST, the marking index 234 is determined to be the EIGHTH marking index. In the example, if the EIGHTH marking index is the color RED, then the area (or portion) to be marked is marked RED. The technique 1100 may be repeated sequentially for all available data within a selected visual area, and any alternate technique to determine marking indices as a function of a boundary status value is contemplated herein.

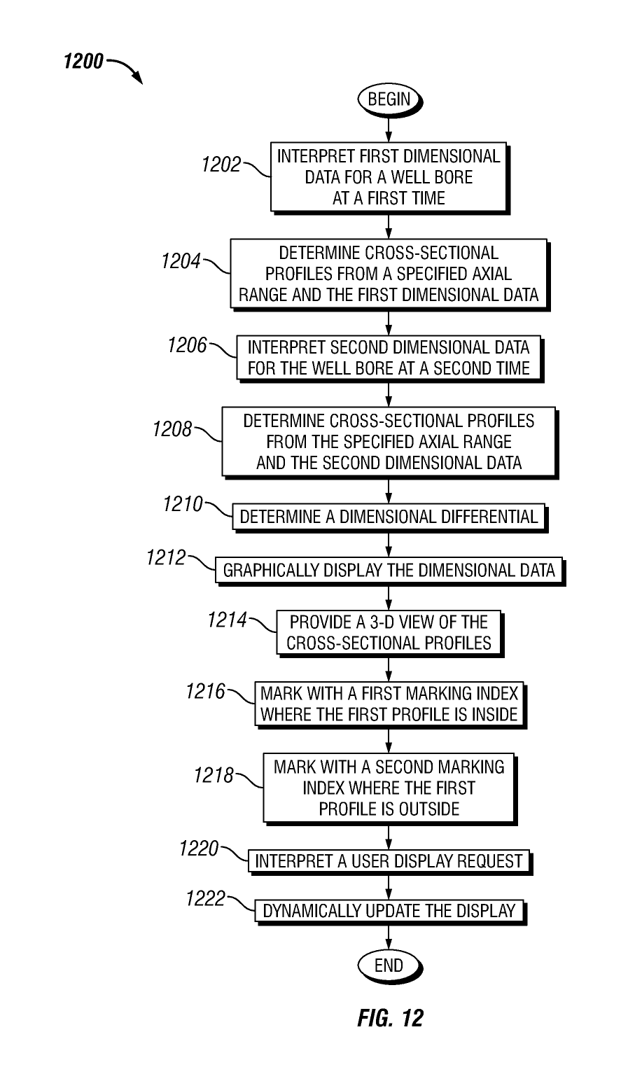

FIG. 12 is a schematic flow diagram of a procedure 1200 for visualizing changes in a volume associated with a wellbore. The procedure includes an operation 1202 to interpret a first dimensional data corresponding to a wellbore at a first time, and an operation 1204 to determine a first number of cross-sectional profiles corresponding to a specified range of axial locations of the wellbore from the first dimensional data. The procedure 1200 further includes an operation 1206 to interpret a second dimensional data corresponding to the wellbore at a second time, and an operation 1208 to determine a second number of cross-sectional profiles corresponding to the specified range of axial locations of the wellbore from the second dimensional data.

The procedure 1200 further includes an operation 1210 to determine a dimensional differential in response to the first dimensional data and the second dimensional data, and an operation 1212 to graphically display the dimensional differential. The operation 1212 includes an operation 1214 to provide a three-dimensional view of the cross-sectional profiles over the specified range of axial locations, an operation 1216 to mark the dimensional differential with a first marking index where one of the first cross-sectional profiles is inside one of the second cross-sectional profiles, and an operation 1218 to mark the dimensional differential with a second marking index where one of the first cross-sectional profiles is outside one of the second cross-sectional profiles. The procedure 1200 further includes an operation 1220 to interpret a user display request and an operation 1222 to dynamically update the graphical display of the dimensional differential in response to the user display request. The user display request includes a specified axial location, a specified range of axial locations, a dimensional data type, a viewing angle, a viewing orientation, a viewing zoom level, and/or a marking index catalog selection.

As is evident from the figures and text presented above, a variety of embodiments according to the present invention are contemplated.

One exemplary embodiment is a method including interpreting a first dimensional data corresponding to a physical boundary defining a cylindrical volume at a first time, and interpreting a second dimensional data corresponding to the physical boundary defining the cylindrical volume at a second time. The method further includes determining a dimensional differential in response to the first dimensional data and the second dimensional data, and graphically displaying the dimensional differential.

In certain embodiments, determining the dimensional differential includes determining a first cross-sectional profile at a specified axial location of the physical boundary from the first dimensional data, and determining a second cross-sectional profile at the specified axial location of the physical boundary from the second dimensional data. The method further includes graphically displaying the dimensional differential by marking the dimensional differential with a first marking index where the first cross-sectional profile is inside the second cross-sectional profile, and marking the dimensional differential with a second marking index where the first cross-sectional profile is outside the second cross-sectional profile.

In certain embodiments, determining the dimensional differential includes determining a first number of cross-sectional profiles corresponding to a specified range of axial locations of the physical boundary from the first dimensional data, and determining a second number of cross-sectional profiles corresponding to the specified range of axial locations of the physical boundary from the second dimensional data. The method further includes graphically displaying the differential data by providing a three-dimensional view of the physical boundary over the specified range of axial locations. The exemplary method includes marking the dimensional differential with a first marking index at positions where the cross-sectional profiles from the first dimensional data are inside the cross-sectional profiles from the second dimensional data, and marking the dimensional differential with a second marking index where the cross-sectional profiles from the first dimensional data are outside the cross-sectional profiles from the second dimensional data.

In certain embodiments, the method includes interpreting a third dimensional data corresponding to the physical boundary defining the cylindrical volume at a third time, and determining the dimensional differential of the physical boundary further in response to the third dimensional data. The method further includes graphically displaying the dimensional differential by showing an inside portion of the physical boundary that is the intersection of the most interior data from the first, second, and third dimensional data. The method further includes marking the inside portion with a third marking index where the first dimensional data is the most interior, marking the inside portion with a fourth marking index where the second dimensional data is the most interior, and marking the inside portion with a fifth marking index where the third dimensional data is the most interior. The method further includes graphically displaying the dimensional differential by showing an outside portion of the physical boundary that is the intersection of the most exterior data from the first, second, and third dimensional data, and marking the outside portion with a sixth marking index where the third dimensional data is the most exterior, marking the outside portion with a seventh marking index where the second dimensional data is the most exterior, and marking the outside portion with an eighth marking index where the first dimensional data is the most exterior.

In another embodiment, determining the dimensional differential includes determining a first cross-sectional profile at a specified axial location of the physical boundary from the first dimensional data, determining a second cross-sectional profile at the specified axial location of the physical boundary from the second dimensional data, and determining a third cross-sectional profile at the specified axial location of the physical boundary from the third dimensional data. The method includes graphically displaying the dimensional differential by marking each interior area with a third marking index, a fourth marking index, or a fifth marking index where the first cross-sectional profile, the second cross-sectional profile, or the third cross-sectional profile, respectively, are the inner-most profile. Each interior area includes the dimensional differential between an inner-most cross-sectional profile and a middle cross-sectional profile. The exemplary method further includes graphically displaying the dimensional differential by marking each exterior area with a sixth marking index, a seventh marking index, or an eighth marking index where the third cross-sectional profile, the second cross-sectional profile, or the first cross-sectional profile, respectively, are the inner-most profile. Each interior area includes the dimensional differential between an inner-most cross-sectional profile and a middle cross-sectional profile. Each exterior area includes the dimensional differential between an outer-most cross-sectional profile and a middle cross-sectional profile.

The method may be performed where the physical boundary defining the cylindrical volume is a wellbore, a pipe, a fluid conduit, a blood vessel, and/or a biological conduit. The dimensional data (first, second, third, or more) includes a physical extent of the physical boundary, an invasion extent of a fluid into a matrix surrounding the physical boundary, and/or a cement bond quality.

Another exemplary embodiment is an apparatus including an interface module that interprets a first dimensional data corresponding to a wellbore at a first time, and that interprets a second dimensional data corresponding to the wellbore at a second time. Each of the first dimensional data and the second dimensional data include an azimuthal aspect. The apparatus further includes a differential module that determines a dimensional differential in response to the first dimensional data and the second dimensional data. The dimensional differential includes a differential volume between the first dimensional data and the second dimensional data. The apparatus further includes a display module that graphically displays the dimensional differential.

In certain embodiments, the differential module further determines a first cross-sectional profile at a specified axial location of the wellbore from the first dimensional data, and determines a second cross-sectional profile at the specified axial location of the wellbore from the second dimensional data. The display module further marks the dimensional differential with a first marking index where the first cross-sectional profile is inside the second cross-sectional profile, and marks the dimensional differential with a second marking index where the first cross-sectional profile is outside the second cross-sectional profile. The interface module further interprets the specified axial location as a dynamic input.

The dimensional data includes caliper log data, fluid invasion log data, and/or cement bonding data. The first dimensional data is taken at a first time, and the second dimensional data is taken at a second time. Other circumstances in addition to time may be varied, for example a cement bond log may be performed at first time and wellbore pressure as the first dimensional data, and the cement bond log may be performed at a second time and wellbore pressure as the second dimensional data.

In certain embodiments, the differential module further determines a first number of cross-sectional profiles corresponding to a specified range of axial locations of the wellbore from the first dimensional data, and determines a second number of cross-sectional profiles corresponding to the specified range of axial locations of the wellbore from the second dimensional data. The display module further provides a three-dimensional view of the cross-sectional profiles over the specified range of axial locations, marking the dimensional differential with a first marking index where the first number of cross-sectional profiles are inside the second number of cross-sectional profiles, and marking the dimensional differential with a second marking index where the first number of cross-sectional profiles are outside the second number of cross-sectional profiles.

In certain embodiments, the interface module further interprets a user display request and the display module dynamically updates the graphical display of the dimensional differential in response to the user display request. The user display request includes a request such as a specified axial location, a specified range of axial locations, a dimensional data type, a viewing angle, a viewing orientation, a viewing zoom level, and/or a marking index catalog selection.

Another exemplary embodiment is a computer program product including a computer useable medium having a computer readable program, where the computer readable program when executed on a computer causes the computer to perform operations to visualize changes in a cylindrical volume. The operations include interpreting a first dimensional data corresponding to a wellbore at a first time, interpreting a second dimensional data corresponding to the wellbore at a second time, determining a dimensional differential in response to the first dimensional data and the second dimensional data, and graphically display the dimensional differential. The operations further include determining a first number of cross-sectional profiles corresponding to a specified range of axial locations of the wellbore from the first dimensional data, and determining a second number of cross-sectional profiles corresponding to the specified range of axial locations of the wellbore from the second dimensional data. The operations further include providing a three-dimensional view of the cross-sectional profiles over the specified range of axial locations. The operations further include marking the dimensional differential with a first marking index where one of the first cross-sectional profiles is inside one of the second cross-sectional profiles, and marking the dimensional differential with a second marking index where one of the first cross-sectional profiles is outside one of the second cross-sectional profiles.

In certain embodiments, the operations further include interpreting a user display request and dynamically updating the graphical display of the dimensional differential in response to the user display request. The user display request includes a specified axial location, a specified range of axial locations, a dimensional data type, a viewing angle, a viewing orientation, a viewing zoom level, and/or a marking index catalog selection.

Yet another embodiment is an apparatus for visualizing a volumetric difference, including an interface module that interprets first dimensional data corresponding to a physical boundary defining a cylindrical volume at a first time, and that interprets second dimensional data corresponding to the physical boundary defining the cylindrical volume at a second time. The apparatus includes a differential module that determines a dimensional differential in response to the first dimensional data and the second dimensional data, and a display module that graphically displays the dimensional differential.

In certain embodiments, the interface module further interprets third dimensional data corresponding to the physical boundary defining the cylindrical volume at a third time, and the differential module determines the dimensional differential of the physical boundary further in response to the third dimensional data. The display module further shows an inside portion of the physical boundary including the intersection of the most interior data from the first, second, and third dimensional data. The display module further marks the inside portion with a third marking index, a fourth marking index, or a fifth marking index, where the first dimensional data, the second dimensional data, or the third dimensional data, respectively, are the most interior data. The display module further shows an outside portion of the physical boundary including the intersection of the most exterior data from the first, second, and third dimensional data. the display module further marks the outside portion with a sixth marking index, a seventh marking index, or an eighth marking index, where the third dimensional data, the second dimensional data, or the first dimensional data, respectively, are the most exterior data.

In certain embodiments, the differential module determines a first cross-sectional profile at a specified axial location of the physical boundary from the first dimensional data, determines a second cross-sectional profile at the specified axial location of the physical boundary from the second dimensional data, and determines a third cross-sectional profile at the specified axial location of the physical boundary from the third dimensional data. The apparatus further includes a marking module that interprets a marking index catalog including a number of marking indices corresponding to a number of boundary status values, each boundary status value including one of the cross-sectional profiles paired with one of the inner-most and outer-most positions. The display module further marks each interior area with the marking index corresponding to the boundary status value matching the inner-most cross-sectional profile, where each interior area is the dimensional differential between an inner-most cross-sectional profile and a middle cross-sectional profile. The display module further marks each exterior area with the marking index corresponding to the boundary status value matching the outer-most cross-sectional profile, where each exterior area is the dimensional differential between an outer-most cross-sectional profile and the middle cross-sectional profile,

Each marking index may be a color, a cross-hatching, a shading, and/or a marked gradient. In certain embodiments, the marking indices each have a distinct appearance. The physical boundary defining the cylindrical volume may be a wellbore, a pipe, a fluid conduit, a blood vessel, and/or a biological conduit. The dimensional data includes a physical extent of the physical boundary, an invasion extent of a fluid into a matrix surrounding the physical boundary, and/or a cement bond quality. In certain embodiments, the dimensional data include an azimuthal aspect.

While the invention has been illustrated and described in detail in the drawings and foregoing description, the same is to be considered as illustrative and not restrictive in character, it being understood that only certain exemplary embodiments have been shown and described and that all changes and modifications that come within the spirit of the inventions are desired to be protected. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A method, comprising:
interpreting a first dimensional data corresponding to a physical boundary defining a cylindrical volume at a first time;
interpreting a second dimensional data corresponding to the physical boundary defining the cylindrical volume at a second time;
determining a dimensional differential in response to the first dimensional data and the second dimensional data; and
graphically displaying the dimensional differential.

2. The method of claim 1, wherein the determining the dimensional differential comprises determining a first cross-sectional profile at a specified axial location of the physical boundary from the first dimensional data, and determining a second cross-sectional profile at the specified axial location of the physical boundary from the second dimensional data.

3. The method of claim 2, wherein the graphically displaying comprises marking the dimensional differential with a first marking index where the first cross-sectional profile is inside the second cross-sectional profile, and marking the dimensional differential with a second marking index where the first cross-sectional profile is outside the second cross-sectional profile.

4. The method of claim 1, wherein the determining the dimensional differential comprises determining a first plurality of cross-sectional profiles corresponding to a specified range of axial locations of the physical boundary from the first dimensional data, and determining a second plurality of cross-sectional profiles corresponding to the specified range of axial locations of the physical boundary from the second dimensional data.

5. The method of claim 4, wherein the graphically displaying comprises providing a three-dimensional view of the physical boundary over the specified range of axial locations, marking the dimensional differential with a first marking index at positions where the first plurality of cross-sectional profiles are inside the second plurality of cross-sectional profiles, and marking the dimensional differential with a second marking index where the first plurality of cross-sectional profiles are outside the second plurality of cross-sectional profiles.

6. The method of claim 1, further comprising interpreting a third dimensional data corresponding to the physical boundary defining the cylindrical volume at a third time, and determining the dimensional differential of the physical boundary further in response to the third dimensional data.

7. The method of claim 6, wherein the graphically displaying comprises showing an inside portion of the physical boundary comprising the intersection of the most interior data from the first, second, and third dimensional data, the method further comprising:
marking the inside portion with a third marking index in response to the first dimensional data being the most interior;
marking the inside portion with a fourth marking index in response to the second dimensional data being the most interior; and
marking the inside portion with a fifth marking index in response to the third dimensional data being the most interior.

8. The method of claim 6, wherein the graphically displaying comprises showing an outside portion of the physical boundary comprising the intersection of the most exterior data from the first, second, and third dimensional data, the method further comprising:
marking the outside portion with a sixth marking index in response to the third dimensional data being the most exterior;
marking the outside portion with a seventh marking index in response to the second dimensional data being the most exterior; and
marking the outside portion with an eighth marking index in response to the first dimensional data being the most exterior.

9. The method of claim 6, wherein the determining the dimensional differential comprises determining a first cross-sectional profile at a specified axial location of the physical boundary from the first dimensional data, determining a second cross-sectional profile at the specified axial location of the physical boundary from the second dimensional data, and determining a third cross-sectional profile at the specified axial location of the physical boundary from the third dimensional data.

10. The method of claim 9, wherein the graphically displaying comprises marking each of at least one interior area comprising the dimensional differential between an inner-most cross-sectional profile and a middle cross-sectional profile and marking each of at least one exterior area comprising the dimensional differential between an outer-most cross-sectional profile and the middle cross-sectional profile, wherein:
the marking each interior area comprises marking with a third marking index in response to the first cross-sectional profile being the inner-most profile, marking with a fourth marking index in response to the second cross-sectional profile being the inner-most profile, and marking with a fifth marking index in response to the third cross-sectional profile being the inner-most profile; and
the marking each exterior area comprises marking with a sixth marking index in response to the third cross-sectional profile being the outer-most profile, marking with a seventh marking index in response to the second cross-sectional profile being the outer-most profile, and marking with an eighth marking index in response to the first cross-sectional profile being the outer-most profile.

11. The method of claim 1, wherein the physical boundary defining the cylindrical volume comprises a boundary selected from the boundaries comprising: a wellbore, a pipe, a fluid conduit, a blood vessel, and a biological conduit.

12. The method of claim 1, wherein the first dimensional data and the second dimensional data comprise data selected from the data consisting of: a physical extent of the physical boundary, an invasion extent of a fluid into a matrix surrounding the physical boundary, and a cement bond quality.

13. An apparatus, comprising:
an interface module structured to interpret a first dimensional data corresponding to a wellbore at a first time, and to interpret a second dimensional data corresponding to the wellbore at a second time, wherein each of the first dimensional data and the second dimensional data comprise an azimuthal aspect;
a differential module structured to determine a dimensional differential in response to the first dimensional data and the second dimensional data; and
a display module structured to graphically display the dimensional differential.

14. The apparatus of claim 13, wherein the differential module is further structured to determine a first cross-sectional profile at a specified axial location of the wellbore from the first dimensional data, and to determine a second cross-sectional profile at the specified axial location of the wellbore from the second dimensional data.

15. The apparatus of claim 14, wherein the display module is further structured to mark the dimensional differential with a first marking index where the first cross-sectional profile is inside the second cross-sectional profile, and to mark the dimensional differential with a second marking index where the first cross-sectional profile is outside the second cross-sectional profile.

16. The apparatus of claim 15, wherein the display module is further structured to mark the dimensional differential with one of a neutral marking index and a reduced intensity marking index when the dimensional differential is below a threshold amount.

17. The apparatus of claim 14, wherein the interface module is further structured to interpret the specified axial location as a dynamic input.

18. The apparatus of claim 13, wherein the first dimensional data comprises caliper log data at the first time, and wherein the second dimensional data comprises caliper log data at the second time.

19. The apparatus of claim 13, wherein the first dimensional data comprises a fluid invasion log data at the first time, and wherein the second dimensional data comprises a fluid invasion log data at the second time.

20. The apparatus of claim 13, wherein the differential module is further structured to determine a first plurality of cross-sectional profiles corresponding to a specified range of axial locations of the wellbore from the first dimensional data, and to determine a second plurality of cross-sectional profiles corresponding to the specified range of axial locations of the wellbore from the second dimensional data.

21. The apparatus of claim 20, wherein the display module is further structured to provide a three-dimensional view of the cross-sectional profiles over the specified range of axial locations, marking the dimensional differential with a first marking index where the first plurality of cross-sectional profiles are inside the second plurality of cross-sectional profiles, and marking the dimensional differential with a second marking index where the first plurality of cross-sectional profiles are outside the second plurality of cross-sectional profiles.

22. The apparatus of claim 13, wherein the interface module is further structured to interpret a user display request and wherein the display module is further structured to dynamically update the graphical display of the dimensional differential in response to the user display request.

23. The apparatus of claim 22, wherein the user display request comprises a request selected from the requests consisting of a specified axial location, a specified range of axial locations, a dimensional data type, a viewing angle, a viewing orientation, a viewing zoom level, and a marking index catalog selection.

24. The apparatus of claim 13, wherein the dimensional differential comprises a differential volume between the first dimensional data and the second dimensional data.

25. A computer program product comprising a computer useable medium having a computer readable program, wherein the computer readable program when executed on a computer causes the computer to:
interpret a first dimensional data corresponding to a wellbore at a first time;
interpret a second dimensional data corresponding to the wellbore at a second time;
determine a dimensional differential in response to the first dimensional data and the second dimensional data; and
graphically display the dimensional differential.

26. The computer program product of claim 25, wherein the computer readable program further causes the computer to:
determine a first plurality of cross-sectional profiles corresponding to a specified range of axial locations of the wellbore from the first dimensional data;
determine a second plurality of cross-sectional profiles corresponding to the specified range of axial locations of the wellbore from the second dimensional data;
provide a three-dimensional view of the cross-sectional profiles over the specified range of axial locations;
mark the dimensional differential with a first marking index where one of the first cross-sectional profiles is inside one of the second cross-sectional profiles; and
mark the dimensional differential with a second marking index where one of the first cross-sectional profiles is outside one of the second cross-sectional profile.

27. The computer program product of claim 25, wherein the computer readable program further causes the computer to: interpret a user display request and dynamically update the graphical display of the dimensional differential in response to the user display request, wherein the user display request comprises a request selected from the requests consisting of a specified axial location, a specified range of axial locations, a dimensional data type, a viewing angle, a viewing orientation, a viewing zoom level, and a marking index catalog selection.

28. An apparatus for visualizing a volumetric difference, comprising:
an interface module structured to interpret a first dimensional data corresponding to a physical boundary defining a cylindrical volume at a first time, and to interpret a second dimensional data corresponding to the physical boundary defining the cylindrical volume at a second time;
a differential module structured to determine a dimensional differential in response to the first dimensional data and the second dimensional data; and
a display module structured to graphically display the dimensional differential.

29. The apparatus of claim 28, wherein the interface module is further structured to interpret a third dimensional data corresponding to the physical boundary defining the cylindrical volume at a third time, and wherein the differential module is structured to determine the dimensional differential of the physical boundary further in response to the third dimensional data.

30. The apparatus of claim 29, wherein the display module is further structured to show an inside portion of the physical boundary comprising the intersection of the most interior data from the first, second, and third dimensional data, and to mark the inside portion with a third marking index in response to the first dimensional data being the most interior, to mark the inside portion with a fourth marking index in response to the second dimensional data being the most interior, and to mark the inside portion with a fifth marking index in response to the third dimensional data being the most interior.

31. The apparatus of claim 29, wherein the display module is further structured to show an outside portion of the physical boundary comprising the intersection of the most exterior data from the first, second, and third dimensional data, and to mark the outside portion with a sixth marking index in response to the third dimensional data being the most exterior, to mark the outside portion with a seventh marking index in response to the second dimensional data being the most exterior, and to mark the outside portion with an eighth marking index in response to the first dimensional data being the most exterior.

32. The apparatus of claim 29, wherein the differential module is further structured to determine a first cross-sectional profile at a specified axial location of the physical boundary from the first dimensional data, to determine a second cross-sectional profile at the specified axial location of the physical boundary from the second dimensional data, and to determine a third cross-sectional profile at the specified axial location of the physical boundary from the third dimensional data.

33. The apparatus of claim 32, further comprising a marking module structured to interpret a marking index catalog comprising a plurality of marking indices corresponding to a plurality of boundary status values each comprising one of the cross-sectional profiles paired with one of the inner-most and outer-most positions;
wherein the display module is further structured to:
mark each of at least one interior area comprising the dimensional differential between an inner-most cross-sectional profile and a middle cross-sectional profile with the marking index corresponding to the boundary status value matching the inner-most cross-sectional profile; and
mark each of the at least one exterior area comprising the dimensional differential between an outer-most cross-sectional profile and the middle cross-sectional profile with the marking index corresponding to the boundary status value matching the outer-most cross-sectional profile.

34. The apparatus of claim 33, wherein the marking indices comprise a marking index selected from the indices consisting of: colors, cross-hatching, shading, and marked gradients.

35. The apparatus of claim 33, wherein the marking indices each comprise a distinct appearance.

36. The apparatus of claim 28, wherein the physical boundary defining the cylindrical volume comprises a boundary selected from the boundaries consisting of: a wellbore, a pipe, a fluid conduit, a blood vessel, and a biological conduit.

37. The apparatus of claim 28, wherein the first dimensional data and the second dimensional data comprise data selected from the data consisting of: a physical extent of the physical boundary, an invasion extent of a fluid into a matrix surrounding the physical boundary, and a cement bond quality.

38. The apparatus of claim 28, wherein the first dimensional data and the second dimensional data comprise an azimuthal aspect.

39. The apparatus of claim 28, wherein the first dimensional data and the second dimensional data are taken at distinct values of a wellbore pressure, an amount of a fluid injected, an amount of a fluid produced, a number of hours of operation, a treatment index value, and an amount of drugs taken by a host of the physical boundary.
